(19) United States
(12) Patent Application Publication
(10) Pub. No.: US 2011/0178262 A1
(43) Pub. Date: Jul. 21, 2011

(54) METHOD FOR IMPROVING THE BUBBLE STABILITY OF A POLYETHYLENE COMPOSITION SUITABLE FOR BLOWN FILM EXTRUSION PROCESS

(75) Inventors: Anthony C. Neubauer, Piscataway, NJ (US); William J. Michie, JR., Missouri City, TX (US)

(73) Assignee: Dow Global Technologies LLC (formerly known as Dow Global Technologies Inc.), Midland, MI (US)

(21) Appl. No.: 13/007,794

(22) Filed: Jan. 17, 2011

Related U.S. Application Data
(60) Provisional application No. 61/296,135, filed on Jan. 19, 2010.

(51) Int. Cl. C08F 6/00; C08F 110/02

(52) U.S. Cl. 526/352

(57) ABSTRACT

The instant invention provides a method for improving the bubble stability of a polyethylene composition suitable for blown film extrusion process. The method for improving the bubble stability of a polyethylene composition suitable for blown film extrusion process comprises the steps of: (1) providing a polyethylene composition having a density in the range of 0.900 g/cm³ to 0.970 g/cm³ and an relaxation spectrum index (RSI) value in the range of 10 to 100; (2) oxygen tailoring said polyethylene composition; (3) thereby forming an oxygen tailored polyethylene composition, wherein the RSI value of the said oxygen tailored polyethylene composition increases from 10% to 300% of its initial value; (4) thereby improving the bubble stability of said polyethylene composition.

### CROSS-REFERENCE TO RELATED APPLICATIONS

This application is a non-provisional application claiming priority from the U.S. Provisional Patent Application No. 61/296,135, filed on Jan. 19, 2010, entitled “METHOD FOR IMPROVING THE BUBBLE STABILITY OF A POLYETHYLENE COMPOSITION SUITABLE FOR BLOWN FILM EXTRUSION PROCESS,” the teachings of which are incorporated by reference herein, as if reproduced in full hereinbelow.

### FIELD OF INVENTION

The instant invention relates to a method for improving the bubble stability of a polyethylene composition suitable for blown film extrusion process.

### BACKGROUND OF THE INVENTION

Almost all polyethylene films are fabricated as either a cast or blown film. Each process has its own advantages and disadvantages. The main difference between the two processes is the manner of cooling an extruded sheet of molten polymer. In general, cast films have a better appearance, and gauge thickness is more readily controlled. Blown films are more evenly oriented in machine and traverse directions; thus, providing greater toughness.

In general, the blown film technique involves extrusion of the plastic through a circular die, followed by expansion, by the pressure of internal air admitted through the center of the mandrel, cooling, and collapsing of the bubble. In operation, the blown film is extruded upward through guiding devices into a set of pinch rolls which collapses the bubble so that it can be wound onto a roll. It can then be split, gusseted, sealed and/or surface treated in line.

Bubble stability is an important aspect of blown film process. Currently, bubble stability of high molecular weight high density polyethylene (HMW HDPE) is typically determined by the use of a commercial scale film line. Although other measurements and techniques such as changes in g′/g″ ratio, gel permeation chromatography (GPC) method, are available, these methods are insensitive to minor changes in long chain branching of the polymer.

Accordingly there is a need for a rheology method which can be used to predict HMW HDPE bubble stability, which is more sensitive when compared to other known methods and eliminates the need to use a full scale commercial film line to predict such bubble stability while maintaining a reduced cost.

### SUMMARY OF THE INVENTION

The instant invention provides a method for improving the bubble stability of a polyethylene composition suitable for blown film extrusion process.

In one embodiment, the method for improving the bubble stability of a polyethylene composition suitable for blown film extrusion process comprises the steps of: (1) providing a polyethylene composition having a density in the range of 0.900 g/cm³ to 0.970 g/cm³ and an relaxation spectrum index (“RSI”) in the range of 10 to 100; (2) oxygen tailoring said polyethylene composition; (3) thereby forming an oxygen tailored polyethylene composition, wherein the RSI value of the said oxygen tailored polyethylene composition increases from 10% to 300% of its initial value; (4) thereby improving the bubble stability of said polyethylene composition.

In an alternative embodiment, the instant invention provides a method for improving the bubble stability of a polyethylene composition suitable for blown film extrusion process, in accordance with any of the preceding embodiments, except that the oxygen tailoring step comprises contacting the polyethylene composition, for example in the molten state, with oxygen.

In an alternative embodiment, the instant invention provides a method for improving the bubble stability of a polyethylene composition suitable for blown film extrusion process, in accordance with any of the preceding embodiments, except that the oxygen tailoring step further comprises thermomechanical treatment of a polyethylene composition in an extruder.

In an alternative embodiment, the instant invention provides a method for improving the bubble stability of a polyethylene composition suitable for blown film extrusion process, in accordance with any of the preceding embodiments, except that the extruder provides a specific energy input in the range of 0.10 kWh per kilogram to 0.50 kWh per kilogram of the polyethylene composition.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is a graph illustrating the relationship between RSI and Bubble Stability Ranking as well as the relationship between g′/g″ and Bubble Stability Ranking; and

FIG. 2 is a graph illustrating the relationship between Percent Increase and Bubble Stability Ranking.

### DETAILED DESCRIPTION OF THE INVENTION

The instant invention provides a method for improving the bubble stability of a polyethylene composition suitable for blown film extrusion process. The method for improving the bubble stability of a polyethylene composition suitable for blown film extrusion process comprises the steps of (1) providing a polyethylene composition having a density in the range of 0.900 g/cm³ to 0.970 g/cm³ and an relaxation spectrum index (RSI) value in the range of 10 to 100; (2) oxygen tailoring said polyethylene composition; (3) thereby forming an oxygen tailored polyethylene composition, wherein the RSI value of the said oxygen tailored polyethylene composition increases from 10% to 300% of its initial value prior to oxygen tailoring; (4) thereby improving the bubble stability of said polyethylene composition.

The term oxygen tailoring, as used herein, refers to the process of contacting the polyethylene composition, for example in the molten state, with oxygen. Oxygen may be as part of a mixture or it may be by itself. Contacting the polyethylene composition with oxygen may occur simultaneously with the thermomechanical treatment of the polyethylene composition in an extruder; or in the alternative, contacting the polyethylene composition, for example in the molten state, with oxygen may be followed with the thermomechanical treatment of the polyethylene composition in extruder. The extruder may be any extruder; for example, the extruder may be a single screw extruder or a multiple screw extruder such as twin screw extruder or continuous mixer. Such extruders are generally known to a person skilled in the art. The extruder may provide a specific mechanical energy in the range of from 0.10 kWh per kilogram to 0.50 kWh per kilogram of the polyethylene composition. All individual values and subranges from 0.10 kWh per kilogram to 0.50 kWh per kilogram are included herein and disclosed herein; for example, the specific energy input can be from a lower limit of 0.10 kWh per kilogram, 0.12 kWh per kilogram, 0.14 kWh per kilogram, or 0.16 kWh per kilogram to an upper limit of 0.24 kWh per kilogram, 0.30 kWh per kilogram, 0.40 kWh per kilogram, or 0.50 kWh per kilogram. For example, the extruder may provide a specific mechanical energy in the range of from 0.10 kWh per kilogram to 0.24 kWh per kilogram of the polyethylene composition; or in the alternative, from 0.12 kWh per kilogram to 0.30 kWh per kilogram; or in the alternative, from 0.14 kWh per kilogram to 0.40 kWh per kilogram; or in the alternative, from 0.16 kWh per kilogram to 0.50 kWh per kilogram.

The polyethylene composition comprises at least one ethylene polymer. The ethylene polymer, which may be an ethylene homopolymer or interpolymer of ethylene, may be readily fabricated into a variety of useful films such as general purpose films, clarity films, or shrink films. For example, ethylene polymer include ethylene homopolymers, and interpolymers of ethylene and linear or branched higher alpha-olefins containing 3 to about 20 carbon atoms. Suitable higher alpha-olefins include, for example, propylene, 1-butene, 1-pentene, 1-hexene, 4-methyl-1-pentene, 1-octene and 3, 5, 5-trimethyl 1-hexene. Dienes, particularly non-conjugated dienes, may also be polymerized with the ethylene. Suitable non-conjugated dienes are linear, branched, or cyclic hydrocarbon dienes having from about 5 to about 20 carbon atoms. Especially preferred dienes include 1,5-hexadiene, 5-vinyl-2-norbornene, 1,7-octadiene and the like. Ethylene polymers also include, for example, ethylene/propylene rubbers (EPR's), ethylene/propylene/diene terpolymers (EPDM's) and the like. Aromatic compounds having vinyl unsaturation, such as styrene and substituted styrenes, may be included as comonomers as well. Particularly preferred ethylene polymers comprise ethylene and 0.1% to about 40% by weight of one or more units derived from the comonomers described above. The polyethylene composition may have a density in the range of 0.900 g/cm³ to 0.970 g/cm³. All individual values and subranges from 0.900 g/cm³ to 0.970 g/cm³ are included herein and disclosed herein; for example, the density can be from a lower limit of 0.900 g/cm³, or 0.910 g/cm³, to an upper limit of 0.960 g/cm³, or 0.970 g/cm³. For example, the density may be in the range of from 0.910 g/cm³ to 0.970 g/cm³, or in the alternative, the density may be in the range of from 0.920 g/cm³ to 0.960 g/cm³. The polyethylene composition may have a high load melt index (I₂₁) in the range of from 2 g/10 minutes to 20 g/10 minutes. All individual values and subranges from 2 g/10 minutes to 20 g/10 minutes are included herein and disclosed herein; for example, the high load melt index (I₂₁) can be from a lower limit of 2 g/10 minutes, 4 g/10 minutes, 5 g/10 minutes, or 6 g/10 minutes to an upper limit of 12 g/10 minutes, 13 g/10 minutes, 14 g/10 minutes, or 20 g/10 minutes. For example, the high load melt index (I₂₁) may be in the range of from 4 g/10 minutes to 12 g/10 minutes; or in the alternative, the high load melt index (I₂₁) may be in the range of from 5 g/10 minutes to 13 g/10 minutes. The polyethylene composition may have a g′/g″ in the range of from 0.2 to 10; for example, in the range of 0.3 to 1. The polyethylene composition may have a molecular weight distribution (M_{w}/Mₙ) in the range of from 2 to 100; for example, in the range of from 8 to 40. The polyethylene composition may have an initial relaxation spectrum index (RSI) value in the range of 10 to 100. The RSI value is dimensionless. The initial RSI value refers to the RSI value of inventive polyethylene composition prior to any oxygen tailoring. The oxygen tailored RSI value of the said oxygen tailored polyethylene composition increases from 10% to 300% of its initial value prior to oxygen tailoring, preferably from 15% to 250%. The oxygen tailored RSI value refers to the RSI value of the inventive oxygen tailored polyethylene composition.

The RSI of the polyethylene composition is determined by first subjecting the polymer to a shear deformation and measuring its response to the deformation using a rheometer. As is known in the art, based on the response of the polymer and the mechanics and geometry of the rheometer used, the relaxation modulus G(t) or the dynamic moduli G′(ω) and G″(ω) may be determined as functions of time t or frequency ω, respectively (See J. M. Dealy and K. F. Wissbrun, Melt Rheology and Its Role in Plastics Processing, Van Nostrand Reinhold, 1990, pp. 269-297). The mathematical connection between the dynamic and storage moduli is a Fourier transform integral relation, but one set of data may also be calculated from the other using the well known relaxation spectrum. See S. H. Wasserman, J. Rheology, Vol. 39, pp. 601-625 (1995) and U.S. Pat. No. 5,798,427, which is fully incorporated herein by reference. Using a classical mechanical model a discrete relaxation spectrum consisting of a series of relaxations or “modes,” each with a characteristic intensity or “weight” and relaxation time may be defined. Using such a spectrum, the moduli are re-expressed as:

$${G}^{′} ( ω ) = {\sum }_{i = 1}^{N} {g}_{i} \frac{{( {ωλ}_{i} )}^{2}}{1 + {( {ωλ}_{i} )}^{2}}$$

$${G}^{″} ( ω ) = {\sum }_{i = 1}^{N} {g}_{i} \frac{{ωλ}_{i}}{1 + {( {ωλ}_{i} )}^{2}}$$

$$G ( t ) = {\sum }_{i = 1}^{N} {g}_{i} exp ( \frac{- t}{{λ}_{i}} )$$

where N is the number of modes and g, and X, are the weight and time for each of the modes (See J. D. Ferry, Viscoelastic Properties of Polymers, John Wiley & Sons, 1980, pp. 224-263). A relaxation spectrum may be defined for the polymer using software such as IRIS® rheological software, which is commercially available from IRIS Development. Once the distribution of modes in the relaxation spectrum is calculated, the first and second moments of the distribution, which are analogous to Mₙ and M_{w}, the first and second moments of the molecular weight distribution, are calculated as follows:

$${g}_{I} = \frac{{\sum }_{i = 1}^{N} {g}_{i}}{{\sum }_{i = 1}^{N} \frac{{g}_{i}}{{λ}_{i}}}$$

$${g}_{II} = \frac{{\sum }_{i = 1}^{N} {g}_{i} {λ}_{i}}{{\sum }_{i = 1}^{N} {g}_{i}}$$

RSI is defined as:

$$R S I = \frac{{g}_{II}}{{g}_{I}}$$

Because RSI is sensitive to such parameters as a polymer's molecular weight distribution, molecular weight, and long chain branching, it is a reliable indicator of the processability of a polymer. The higher the value of RSI, the better the processability of the polymer.

Any conventional ethylene polymerization process may be employed to produce the polyethylene compositions suitable for blown film process. Such conventional ethylene polymerization processes include, but are not limited to, gas phase polymerization, slurry phase polymerization, solution phase polymerization, and combinations thereof using conventional reactors, e.g., gas phase reactors, loop reactors, stirred tank reactors, and batch reactors in series, or in series and parallel. The polymerization system may be a single polymerization system, a dual sequential polymerization system, or a multi-sequential polymerization system. Examples of dual sequential polymerization system include, but are not limited to, gas phase polymerization/gas phase polymerization; gas phase polymerization/solution phase polymerization; solution phase polymerization/gas phase polymerization; solution phase polymerization/solution phase polymerization; slurry phase polymerization/slurry phase polymerization; solution phase polymerization/slurry phase polymerization; slurry phase polymerization/solution phase polymerization; slurry phase polymerization/gas phase polymerization; and gas phase polymerization/slurry phase polymerization. The multi-sequential polymerization systems may include at least two or more polymerization systems. Pre-polymerization may also be employed for any reaction system, for example, the pre-polymerization reactor would precede any of the above combinations.

The catalyst system may also be a conventional catalyst system. Similarly, catalysts compositions that may be used to make the ethylene polymers of the invention are any of those known for the polymerization of ethylene, such as those comprising one or more conventional Ziegler-Natta catalysts, chrome or modified chrome catalysts (aluminum, phosphorous etc.), nickel based catalysts, as well as any metallocene or single site catalysts, all of which are well documented in the literature. The use of a mixed catalyst system within or among catalyst families may also be used to make the ethylene polymers of the invention.

In one production embodiment, polymerization may be conducted in the gas phase in a stirred or fluidized bed reactor, using equipment and procedures well known in the art. Preferably, pressures in the range of 1 psig (6.9 kPag) to 1000 psig (6.9 MPag), preferably 50 psig (345 kPag) to 400 psig (2.76 MPag), and most preferably 100 psig (690 kPag) to 300 psig (2.07 MPag), and temperatures in the range of 30° C. to 130° C., preferably 65° C. to 120° C. are used. Ethylene and other monomers, if used, are contacted with an effective amount of catalyst composition at a temperature and a pressure sufficient to initiate polymerization.

Suitable gas phase polymerization reaction systems comprise a reactor to which monomer(s) and catalyst composition may be added, and that contain a bed of forming polyethylene particles. The invention is not limited to any specific type of gas phase reaction system. As an example, a conventional fluidized bed process is conducted by passing a gaseous stream containing one or more monomers continuously through a fluidized bed reactor under reaction conditions and in the presence of catalyst composition at a velocity sufficient to maintain the bed of solid particles in a suspended condition. The gaseous stream containing unreacted gaseous monomer is withdrawn from the reactor continuously, compressed, cooled and recycled into the reactor. Product is withdrawn from the reactor and make-up monomer is added to the recycle stream.

Conventional additives may be included in the process, provided they do not interfere with the polymerization process described herein as well as the properties of the polyethylene compositions made therewith.

When hydrogen is used as a chain transfer agent in the gas phase polymerization process, it is used in amounts varying between about 0.001 mole to about 10 mole of hydrogen per mole of total monomer feed. Also, as desired for temperature control of the system, any gas inert to the catalyst composition and reactants can also be present in the gas stream.

In an alternative production embodiment, a dual sequential polymerization system connected in series may be used.

In another alternative production embodiment, a catalyst system including a cocatalyst, ethylene, one or more alpha-olefin comonomers, hydrogen, and optionally inert gases and/or liquids, e.g., nitrogen, isopentane, and hexane, are continuously fed into a first reactor to form a first component. The first reactor may be connected to a second reactor in series. The first component/active catalyst mixture is then continuously transferred, for example, in batches from the first reactor to the second reactor. Ethylene, hydrogen, cocatalyst, and optionally inert gases and/or liquids, e.g., nitrogen, isopentane, hexane, are continuously fed to the second reactor, and the product, i.e., the polyethylene composition is continuously removed, for example, in batches from the second reactor. A preferred mode is to take batch quantities of first component from the first reactor, and transfer these to the second reactor using the differential pressure generated by a recycled gas compression system. The polyethylene composition is then transferred to a purge bin under inert atmosphere conditions. Subsequently, the residual hydrocarbons are removed, and moisture is introduced to reduce any residual aluminum alkyls and any residual catalysts before the polyethylene composition is exposed to oxygen.

The polyethylene composition is then transferred to an extruder, wherein it is exposed to oxygen, for example in the molten state. Such oxygen tailoring processes are well known in the art. The oxygen may be present in the amount of less than 21% (wt/wt); for example, oxygen is present in the range of 0.5% (wt/wt) to 21% (wt/wt); or in the alternative, from 0.5% (wt/wt) to 10% (wt/wt). The extruder may provide a specific energy input in the range of from 0.10 kWh per kilogram to 0.50 kWh per kilogram; for example, 0.13 kWh per kilogram to 0.27 kWh per kilogram. The oxygen tailored polyethylene composition having improved bubble stability may further be melt screened by processing through one or more active screens (positioned in series of more than one) with each active screen having a micron retention size of from about 2 μm to about 400 μm, and preferably about 2 μm to about 300 and most preferably about 2 μm to about 70 μm, at a mass flux of about 5 lb/hr/in² to about 100 lb/hr/in² (1.0 kg/s/m² to about 20 kg/s/m²). Such further melt screening is disclosed in U.S. Pat. No. 6,485,662, which is incorporated herein by reference to the extent that it discloses melt screening. The oxygen tailored polyethylene composition having improved bubble stability is then pelletized. Such pelletization techniques are generally known.

The oxygen tailored polyethylene composition may further be modified via peroxide addition, irradiation, azide coupling, and any combinations thereof. Such further modifications are well known in the art.

The oxygen tailored polyethylene compositions may be blended with other polymers and resins as desired using techniques known in the art. In addition, various additives and agents, such as thermo-oxidation and photo-oxidation stabilizers including hindered phenolic antioxidants, hindered amine light stabilizers and aryl phosphites or phosphonites, crosslinkers including dicumyl peroxide, colorants including carbon blacks and titanium dioxide, lubricants including metallic stearates, processing aids including fluoroelastomers, slip agents including oleamide or erucamide, film antiblock or release agents including controlled particle size talc or silica, blowing agents, flame retardants, nucleators, and other conventional materials may be mixed with the oxygen tailored polyethylene composition of the invention as desired. The oxygen tailored polyethylene compositions having improved bubble stability are useful for fabrication into a variety of finished articles such as films including clarity films and shrink films. Different methods may be employed to form such film; for example, films may be formed via blown film extrusion process.

In blown film extrusion process, the oxygen tailored polyethylene composition having improved bubble stability is provided. The oxygen tailored polyethylene composition having improved bubble stability is melt extruded through an annular circular die thereby forming a tube. The tube is expanded by air, for example two or three times its diameter, and at the same time, the cooled air chills the web to a solid state. The degree of blowing or stretch determines the balance and level of tensile and impact properties. An internal air cooling ring may be used as well, in order to increase throughput rates and optical quality. Rapid cooling is essential to achieve the crystalline structure necessary to give clear, glossy films. The film tube is then collapsed within a V-shaped frame of rollers and is nipped at the end of the frame to trap the air within the bubble. The nip rolls also draw the film away from the die. The draw rate is controlled to balance the physical properties with the transverse properties achieved by the blow draw ratio. The tube may be wound as such or may be slit and wound as a single-film layer onto one or more rolls. The tube may also be directly processed into bags.

### EXAMPLES

The following examples illustrate the present invention but are not intended to limit the scope of the invention.

### Inventive Example 1

Inventive Example 1 is a high density polyethylene composition which was oxygen tailored. The processing conditions as well as the bubble stability properties of the Inventive Example 1 are reported in Table I and Table II.

### Comparative Example A

Comparative Example A is a high density polyethylene composition which was not oxygen tailored. The processing conditions as well as the bubble stability properties of the Comparative Example A are reported in Table I and Table II.

### Comparative Example B

Comparative Example B is a high density polyethylene composition which was oxygen tailored. The processing conditions as well as the bubble stability properties of the Comparative Example B are reported in Table I and Table II.

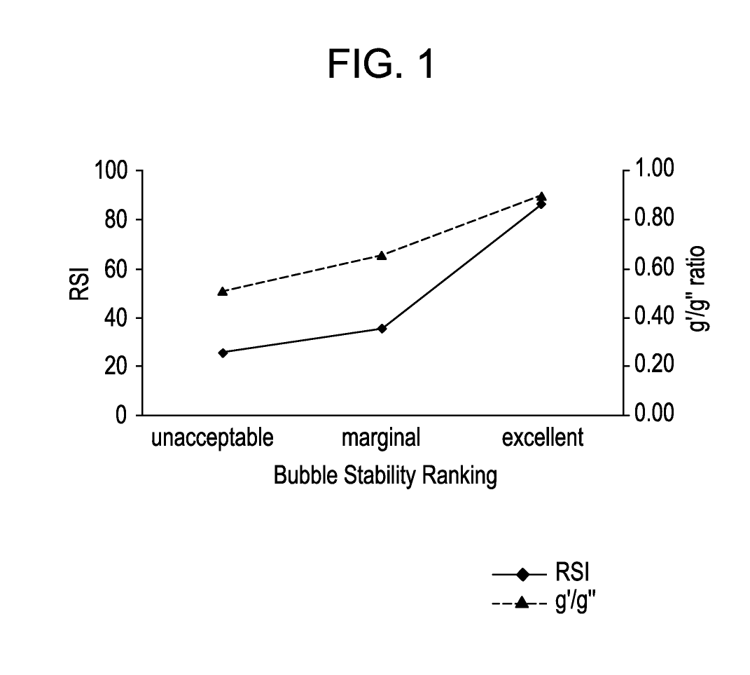

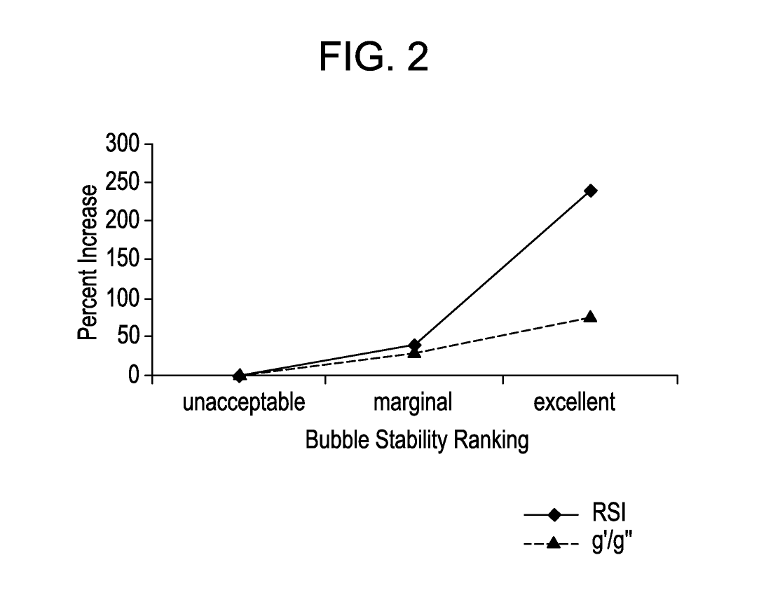

The RSI relationship as well as g′/g″ relationship of Inventive Example 1 and Comparative Example A and B are graphically shown in FIGS. 1 and 2, which clearly show that the RSI index is much more sensitive to low levels of long chain branching, which may impact bubble stability, than the changes in g′/g″.

TABLE I

| | | | | Processing Rate | | | | | |
|---|---|---|---|---|---|---|---|---|---|
| | Density, | I₂₁, | O_{2,} % | (throughput rate in | SEI, | M_{w}, | Mₙ, | | g′/g″ at 0.1 1/s |
| | g/cm³ | dg/min | (wt/wt) | compounding unit), kg/h | kWh/kg | g/gmole | g/gmole | RSI | and 190° C. |
| Inventive Ex. 1 | 0.949 | 9.5 | 6.0 | 20,400 | 0.188 | 215,000 | 11,600 | 85.8 | 0.892 |
| Comparative Ex. A | 0.948 | 9.0 | 0.0 | 18,200 | 0.197 | 235,000 | 11,200 | 25.3 | 0.504 |
| Comparative Ex. B | 0.948 | 8.7 | 0.5 | 20,800 | 0.180 | 227,000 | 11,010 | 35.3 | 0.650 |

TABLE II

| | Maximum Winder | Bubble Stability |
|---|---|---|
| | Speed, ft/min (m/s) | Ranking |
| Inventive Ex. 1 | 350 (1.8) | Excellent |
| Comparative Ex. A | 90 (0.46) | Unacceptable |
| Comparative Ex. B | 270 (1.4) | Marginal |

### Test Methods

Test methods include the following:

Weight average molecular weight (M_{w}) and number average molecular weight (Mₙ) were determined according to methods known in the art using triple detector GPC, as described herein below.

The molecular weight distributions of the ethylene polymers were determined by gel permeation chromatography (GPC). The chromatographic system consisted of a Waters (Millford, Mass.) 150° C. high temperature gel permeation chromatograph, equipped with a Precision Detectors (Amherst, Mass.) 2-angle laser light scattering detector Model 2040. The 15° angle of the light scattering detector was used for calculation purposes. Data collection was performed using Viscotek TriSEC software Version 3 and a 4-channel Viscotek Data Manager DM400. The system was equipped with an on-line solvent degas device from Polymer Laboratories. The carousel compartment was operated at 140° C. and the column compartment was operated at 150° C. The columns used were four Shodex HT 806M 300 mm, 13 μm columns and one Shodex HT803M 150 mm, 12 μm column. The solvent used was 1,2,4 trichlorobenzene. The samples were prepared at a concentration of 0.1 gram of polymer in 50 milliliter of solvent. The chromatographic solvent and the sample preparation solvent contained 200 μg/g of butylated hydroxytoluene (BHT). Both solvent sources were nitrogen sparged. Polyethylene samples were stirred gently at 160° C. for 4 hours. The injection volume used was 200 microliter, and the flow rate was 0.67 milliliter/min. Calibration of the GPC column set was performed with 21 narrow molecular weight distribution polystyrene standards, with molecular weights ranging from 580 g/gmole to 8,400,000 g/gmol, which were arranged in 6 “cocktail” mixtures with at least a decade of separation between individual molecular weights. The standards were purchased from Polymer Laboratories (Shropshire, UK). The polystyrene standards were prepared at 0.025 gram in 50 milliliter of solvent for molecular weights equal to, or greater than, 1,000,000 g/gmol, and 0.05 gram in 50 milliliter of solvent for molecular weights less than 1,000,000 g/gmol. The polystyrene standards were dissolved at 80° C. with gentle agitation for 30 minutes. The narrow standards mixtures were run first, and in order of decreasing highest molecular weight component, to minimize degradation. The polystyrene standard peak molecular weights were converted to polyethylene molecular weights using the following equation (as described in Williams and Ward, J. Polym. Sci., Polym. Let., 6, 621 (1968)):

M_{polyethylene}=A×(M_{polystyrene})^{B}

where M is the molecular weight, A has a value of 0.41 and B is equal to 1.0. The Systematic Approach for the determination of multi-detector offsets was done in a manner consistent with that published by Balke, Mourey, et al. (Mourey and Balke, Chromatography Polym. Chpt 12, (1992) and Balke, Thitiratsakul, Lew, Cheung, Mourey, Chromatography Polym. Chpt 13, (1992)), optimizing dual detector log results from Dow broad polystyrene 1683 to the narrow standard column calibration results from the narrow standards calibration curve using in-house software. The molecular weight data for off-set determination was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The overall injected concentration used for the determination of the molecular weight was obtained from the sample refractive index area and the refractive index detector calibration from a linear polyethylene homopolymer of 115,000 g/gmol molecular weight, which was measured in reference to NIST polyethylene homopolymer Standard 1475. The chromatographic concentrations were assumed low enough to eliminate addressing 2^{nd} Virial coefficient effects (concentration effects on molecular weight). Molecular weight calculations were performed using in-house software. The calculation of the number average molecular weight, Mₙ, and weight average molecular weight, M_{w}, were made according to the following equations, assuming that the refractometer signal is directly proportional to weight fraction. The baseline-subtracted refractometer signal can be directly substituted for weight fraction in the equations below. Note that the molecular weight can be from the conventional calibration curve or the absolute molecular weight from the light scattering to refractometer ratio.

$$\overline{Mn} = \frac{{\sum }^{i} {Wf}_{i}}{{\sum }^{i} ( {Wf}_{i} / {M}_{i} )}$$

$$\overline{Mw} = \frac{{\sum }^{i} ( {Wf}_{i} * {M}_{i} )}{{\sum }^{i} {Wf}_{i}}$$

Resin density was measured by the Archimedes displacement method, ASTM D 792-03, Method B, in isopropanol. Specimens (about 45 mm in diameter and about 2 mm thick) were measured within one hour of molding, after conditioning in an isopropanol bath at 23° C. for eight minutes, to achieve thermal equilibrium prior to measurement. The specimens were compression molded according to ASTM D-4703-00, Annex A, with a five minute initial heating period, at approximately 190° C. and 100 psig (690 kPag), 3 minute heating period at approximately 190° C. at 1500 psig (10.3 MPag), and then cool at 15° C. per minute cooling rate at 1500 psig (10.3 MPag) per Procedure C to 45° C., and continued cooling until “cool to the touch”.

Melt flow rate measurements were performed according to ASTM D-1238-04, Condition 190° C. with 21.6 kg weight, which is known as high load melt index (I₂₁). Melt flow rate is inversely proportional to the molecular weight of the polymer. Thus, the higher the molecular weight, the lower the melt flow rate, although the relationship is not linear.

Failure of bubble stability is defined as the inability to control the bubble, and to form film with excellent gauge (thickness) uniformity. Bubble stability is measured on the following blown film line, commercially available from Hosokawa Alpine Corporation, under the following conditions:

Extruder and film line operating parameters

| | | |
|---|---|---|
| Barrel Zone 1 | 390° F. | (199° C.) |
| Barrel Zone 2 | 400° F. | (204° C.) |
| Adapter Bottom | 400° F. | (204° C.) |
| Adapter Vertical | 410° F. | (210° C.) |
| Bottom Die | 410° F. | (210° C.) |
| Middle Die | 410° F. | (210° C.) |
| Top Die | 410° F. | (210° C.) |
| Output Rate | 100 lb/h | (45.4 kg/h) |
| Blow up ratio (BUR) | 4:1 | |
| Neck height | 32 inch | (0.81 m) |
| Frost line height | 42 inch | (1.07 m) |
| Melt temperature | 410° F. | (210° C.) |
| Lay Flat Width | 25.25 inch | (0.64 m) |
| Film Thicknesses | 0.001 inch (1.0 mil) | (25 μm) |
| | 0.0005 inch (0.5 mil) | (13 μm) |

Blown Film Equipment Description
Alpine HS50S stationary extrusion system
   50 mm 21:1 L/D grooved feed extruder
   60 hp (44.8 kW) DC drive
   extruder has a cylindrical screen changer
   standard control panel with nine RKC temperature controllers
Alpine Die BF 10-25
   12 spiral design
   complete with insert to make up a 100 mm die diameter
Alpine Air Ring HK 300
   single lip design
   air lips for a 100 mm die diameter
   7.5 hp (5.6 kW) blower with variable speed AC drive
Bubble calibration Iris Model KI 10-65
   layflat width (LFW) range 7 inch to 39 inch (0.178 m to 0.991 m)
Alpine Take-Off Model A8
   collapsing frame with side guides with hard wood slats
   maximum layflat width (LFW): 31 inch (0.787 m)
   roller face width: 35 inch (0.889 m)
   maximum takeoff speed: 500 ft/min (2.54 m/s)
   4 idler rolls
Alpine surface winder Model WS8
   maximum LFW: 31 inch (0.787 m)
   roller face width: 35 inch (0.889 m)
   maximum line speed: 500 ft/min (2.54 m/s)
   automatic cutover

Unless stated otherwise, gravimetric feed was used. Blowing and winding were initiated and established at an output rate of 100 lb/h (45.4 kg/h) and winder speed of 82.5 ft/min (0.42 m/s), with a neck height of 32.0 in (0.81 m), with a layflat width of 24.5 in (0.622 m), with a symmetrical bubble producing a film approximately 0.001 inch (1.0 mil; 25 μm) thick. These conditions were maintained for at least 20 minutes and the bubble blown in the process was visually observed for helical instability or bubble diameter oscillation. Helical instability involves decreases in diameter in a helical pattern around the bubble. Bubble diameter oscillation involves alternating larger and smaller diameters. A bubble is considered stable, in others words passing, as long as neither of these conditions (helical instability and bubble diameter oscillation) is observed during about ten minutes of operation, even though some bubble chatter may be observed. While a constant extruder output rate of 100 lb/hr (45.4 kg/h) was maintained, the winder speed was increased to decrease the film thickness until the bubble becomes unstable. The winder speed was increased in about 10 ft/min (0.05 m/s) increments while the air ring blower setting was adjusted to maintain the neck height. At each increment, the bubble blown in the process was visually observed for helical instability or bubble diameter oscillation. The winder speed at which the bubble became unstable was recorded as the maximum winder speed.

The resin rheology was measured on the ARES I (Advanced Rheometric Expansion System) Rheometer. The ARES is a strain controlled rheometer. A rotary actuator (servomotor) applies shear deformation in the form of strain to a sample. The sample composition was compression molded into a disk for rheology measurement. The disks were prepared by pressing the samples into 0.071 inch (1.8 mm) thick plaques, and were subsequently cut into “one inch (25.4 mm) diameter” disks. The compression molding procedure was as follows: 365° F. (185° C.) for 5 min at 100 psig (689 kPag); 365° F. (185° C.) for 3 min at 1500 psig (10.3 MPag); cooling at 27° F. (15° C.) per minute to ambient temperature (about 23° C.).

In response, the sample generates torque, which is measured by the transducer. Strain and torque are used to calculate dynamic mechanical properties, such as modulus and viscosity. The viscoelastic properties of the sample were measured in the melt using a parallel plate set up, at constant strain (10%) and temperature (190° C.), and as a function of varying frequency (0.01 s⁻¹ to 100 s⁻¹). The storage modulus (G′), loss modulus (G″), tan delta, and complex viscosity (eta*) of the resin were determined using Rheometrics Orchestrator software (v. 6.5.8). The RSI values were determined using IRIS® rheological software which is commercially available from IRIS Development.

The present invention may be embodied in other forms without departing from the spirit and the essential attributes thereof, and, accordingly, reference should be made to the appended claims, rather than to the foregoing specification, as indicating the scope of the invention.

We claim:

1. A method for improving the bubble stability of a polyethylene composition suitable for blown film extrusion process comprising the steps of:
providing a polyethylene composition having a density in the range of 0.900 g/cm³ to 0.970 g/cm³ and an relaxation spectrum index (RSI) value in the range of 10 to 100;
oxygen tailoring said polyethylene composition;
thereby forming an oxygen tailored polyethylene composition, wherein the RSI value of the said oxygen tailored polyethylene composition increases from 10% to 300% of its initial value;
thereby improving the bubble stability of said polyethylene composition.

2. The method for improving the bubble stability of a polyethylene composition suitable for blown film extrusion process of claim 1, wherein said oxygen tailoring step comprises contacting said polyethylene composition in the molten state with oxygen.

3. The method for improving the bubble stability of a polyethylene composition suitable for blown film extrusion process of claim 2, wherein said oxygen tailoring step further comprises thermomechanical treatment of said polyethylene composition in an extruder.

4. The method for improving the bubble stability of a polyethylene composition suitable for blown film extrusion process of claim 3, wherein said extruder provides a specific energy input in the range of 0.10 kWh per kilogram to 0.50 kWh per kilogram of said polyethylene composition.

5. A polyethylene composition having improved bubble stability, wherein said polyethylene composition is produced according to the process of claim 1.
